(19) United States
(12) Patent Application Publication
(10) Pub. No.: US 2010/0140321 A1
(43) Pub. Date: Jun. 10, 2010

(54) FRICTION STIR WELDING APPARATUS AND METHOD

(75) Inventors: Michael R. ELLER, New Orleans, LA (US); Drew P. ROUSSEL, Gonzales, LA (US); Zhixian LI, Slidell, LA (US)

Correspondence Address: MCDERMOTT WILL & EMERY LLP, 18191 VON KARMAN AVE., SUITE 500, IRVINE, CA, 92612-7108, US

(73) Assignee: LOCKHEED MARTIN CORPORATION, Bethesda, MD (US)

(21) Appl. No.: 12/629,780

(22) Filed: Dec. 2, 2009

Related U.S. Application Data
(60) Provisional application No. 61/121,476, filed on Dec. 10, 2008.

(51) Int. Cl. B23K 20/12

(52) U.S. Cl. 228/2.1

(57) ABSTRACT

A friction stir welding device may include a rotatable head, a rotatable upper shoulder, a lower shoulder and a pin device. The rotatable head includes a first multisided connection portion. The rotatable upper shoulder includes a first cavity and a second multisided connection portion. The second multisided connection portion is configured to engage the first multisided connection portion. The lower shoulder includes a second cavity and a third multisided connection portion. The pin device includes a first end and a second end. At least a portion of the second end includes a fourth multisided connection portion. The fourth multisided connection portion can be configured to engage the third multisided connection portion. The pin device may be configured to retractably traverse the rotatable upper shoulder via the first cavity. The rotatable upper shoulder, the pin device and the lower shoulder may be configured to friction stir weld a workpiece.

### CROSS-REFERENCES TO RELATED APPLICATIONS

The present application claims the benefit of U.S. Provisional Patent Application Ser. No. 61/121,476, entitled “TOOL DESIGN FOR SELF-REACTING FRICTION STIR WELDING OF HIGH TEMPERATURE ALLOYS,” filed on Dec. 10, 2008, which is hereby incorporated by reference in its entirety for all purposes.

### STATEMENT REGARDING FEDERALLY SPONSORED RESEARCH OR DEVELOPMENT

Not applicable.

### FIELD

The subject technology generally relates to friction stir welding, and more particularly to, friction stir welding apparatus and method.

### BACKGROUND

Friction stir welding (FSW) is a solid-state joining process and offers several advantages over fusion welding processes including, for example, higher joint strength and lower distortion. Furthermore, a friction stir welding process can join alloys that may not be welded by fusion welding processes. These advantages make a friction stir welding process a valuable joining process in many industries including the aerospace industry.

### SUMMARY

In one aspect of the disclosure, a friction stir welding apparatus may comprise a head, a rotatable upper shoulder, a lower shoulder, and a pin device. The head may comprise a first multisided connection portion. The rotatable upper shoulder may comprise a first cavity therethrough and a second multisided connection portion. The second multisided connection portion may be configured to engage the first multisided connection portion of the head. The lower shoulder may comprise a second cavity therethrough and a third multisided connection portion. The pin device may comprise a first end and a second end. At least a portion of the second end may comprise a fourth multisided connection portion. The fourth multisided connection portion of the pin device may be configured to engage the third multisided connection portion. The pin device may be configured to retractably traverse the rotatable upper shoulder via the first cavity. The rotatable upper shoulder, the pin device and the lower shoulder may be configured to friction stir weld a workpiece.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology.

Accordingly, the drawings and detailed description are to be regarded as illustrative in nature and not as restrictive.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1A is a simplified view illustrating an example of a fixed pin tool or device for use in friction stir welding.

FIG. 1B is a simplified view illustrating an example of a retractable pin tool device for use in friction stir welding.

FIG. 1C is a simplified view illustrating an example of a fixed pin tool or device during welding of a workpiece.

FIG. 1D is a simplified view illustrating an example of a retractable pin tool device during welding of a workpiece.

FIG. 2 is a simplified view illustrating an example of a screw retaining friction stir welding tool.

FIG. 3A is a simplified view illustrating an example of a friction stir welding tool with a severe deformation at a set screw.

FIG. 3B is a simplified view illustrating an example of a severely deformed and fractured friction stir welding tool at a set screw location.

FIG. 4A is a simplified view illustrating an example of a self-reacting friction stir welding device for use in friction stir welding.

FIG. 4B is a simplified view illustrating an example of a self-reacting friction stir welding device during welding of a workpiece.

FIG. 5A illustrates an example of a pin tool or pin tool device in accordance with various aspects of the subject disclosure.

FIG. 5B is an exploded view of the pin tool device of FIG. 5A.

FIG. 5C is an example of a schematic cross-sectional view of one configuration of the pin tool device of FIG. 5A.

FIG. 6 is an example exploded view of a lower section of the pin tool device of FIG. 5A.

FIG. 7A and FIG. 7B illustrate examples of a self-reacting friction stir welding tool or device in accordance with various aspects of the subject disclosure.

FIG. 8 illustrates an example of the pin tool device of FIG. 5A in contact with a workpiece during welding.

FIG. 9 illustrates an example of welding equipment according to one configuration of the subject technology.

FIG. 10 illustrates an example of a top plan view of welding equipment.

FIG. 11 illustrates one example of welding equipment.

FIG. 12A and FIG. 12B illustrate examples of a workpiece after welding.

FIG. 13 illustrates an example of a friction stir welding process according to one configuration of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology Like or similar components may be labeled with identical element numbers for ease of understanding or it may indicated in the disclosure that one component may be an example of a different component.

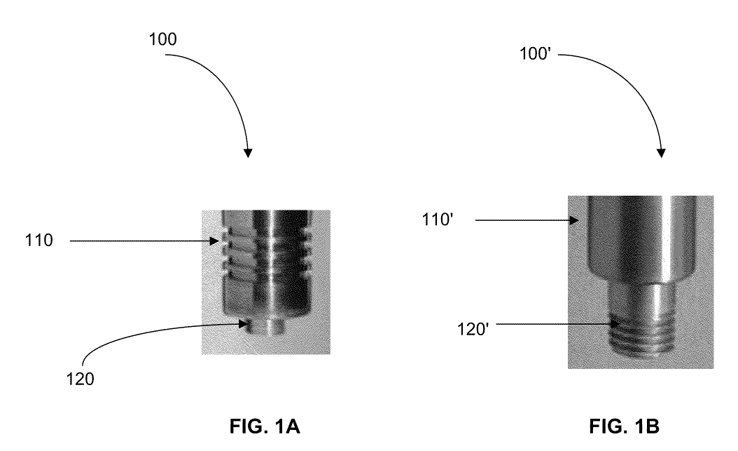

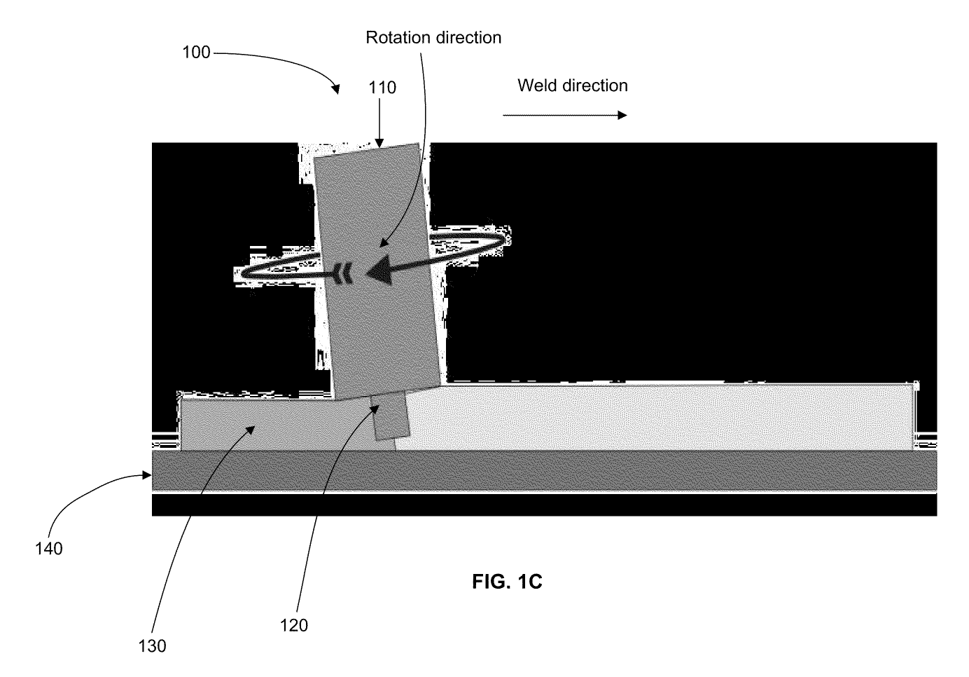

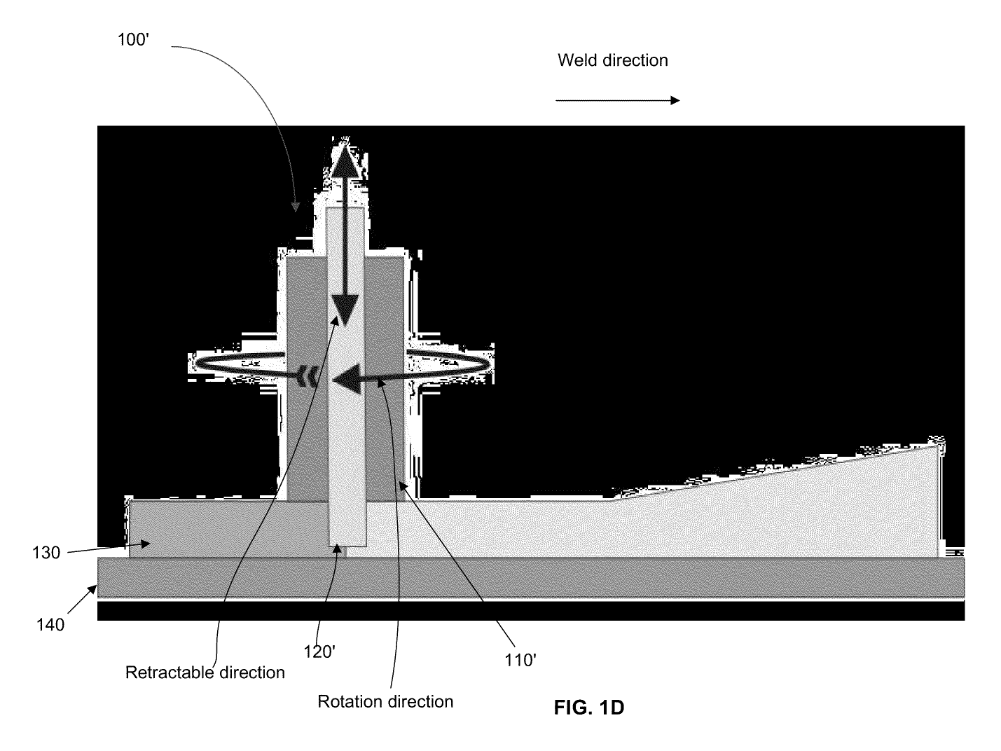

There are several different techniques used for friction stir welding processes (e.g., friction stir welding process or self-reacting friction stir welding process). A first technique is a fixed pin tool technique illustrated in FIG. 1A. The fixed pin tool technique may be implemented with a pin tool or pin tool device such as a fixed pin tool 100 comprising a shoulder 110 and a pin 120. The fixed pin tool technique is a welding process where the fixed pin tool 100 is made of single piece of material (including the pin 120 and shoulder 110) and the pin length is constant. However, fixed pin tool technique can only weld plates with a constant thickness. Further, the pin 120 and the shoulder 110 spin together and may not move independently of each other as illustrated in FIG. 1C.

A second technique is a retractable pin tool (RPT) technique, illustrated in FIG. 1B that utilizes a pin tool or pin tool device such as a retractable pin tool 100′. The RPT 100′ comprises a shoulder 110′ and a pin 120′. In RPT mode, the pin 120′ can move up and down independently from a shoulder 110′ in order to change the pin length (see FIG. 1D). However, with the RPT technique, the pin 120′ and the shoulder 110′ spin together (see FIG. 1D). The RPT technique can weld plates with a tapered thickness or close out the pin exit space (i.e. the space occupied by the pin during welding of one or more workpieces) by slowly retracting the pin back during welding.

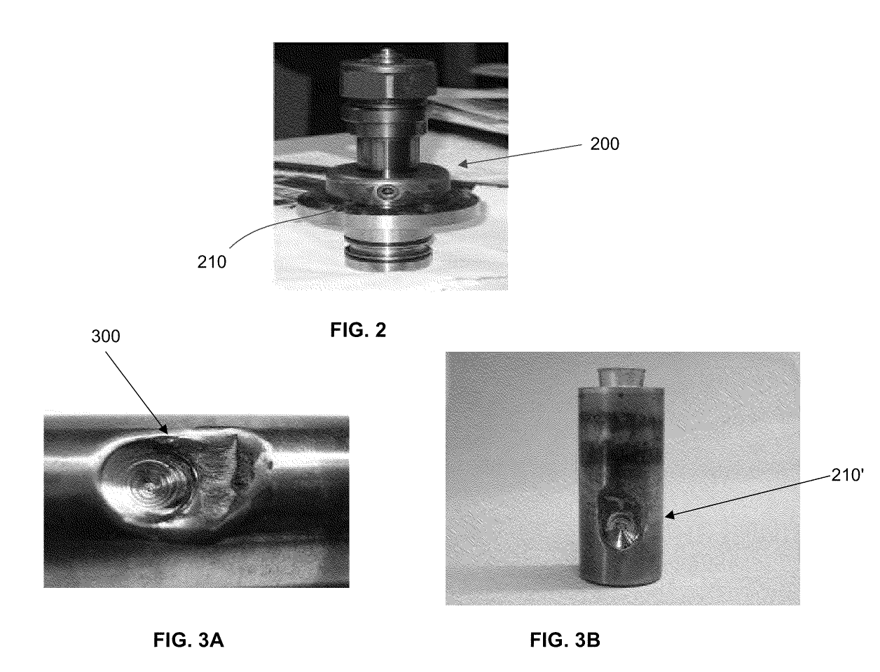

Developing friction stir welding (FSW) processes for high temperature alloys is useful for many industries and organizations such as commercial industries and governmental and educational organizations. Attempts at joining these high temperature alloys can utilize a fixed pin tool technique or an RPT technique. The method of securing the pin tool to a head or welding head 200 uses a set screw 210 to withstand torque induced by the pin tool, and the set screw may reduce the tendency of the tool from dropping out of the head or welding head 200, as illustrated in FIG. 2. The set screw 210 is typically a smaller diameter screw that is threaded through the head (or adapter) 200 and makes contact with a flat or recess on the pin tool as illustrated in FIG. 2.

The single point retaining set screw method described above has several shortcomings when friction stir welding high temperature alloys. Refractory metals such as tungsten alloys are typically used as pin tool materials when friction stir welding high temperature alloys. The tungsten alloys used for the top shoulder are brittle. Thus, stress concentrations at the set screw contact point can cause deformation or shearing, for example, at locations 300 of FIG. 3A, of the pin tool in that region. The set screws 210 can also be deformed, sheared, and/or stuck in the welding head. For example, FIG. 3B illustrates a deformed set screw 210′. Since the set screw 210′ point/tip is taking all the torque and loading, it does not have desirable outcomes when used with refractory metal pin tools such as tungsten.

While progress has been made on FSW of high-temperature alloys using fixed pin tool and RPT techniques due to their simple tooling and process, these techniques still face a serious challenge on FSW of high-temperature alloys. It is difficult to obtain full penetration welds using both fixed pin tool and RPT techniques. The process window to achieve full penetration friction stir welds for high-temperature alloys is much smaller than their counterpart, aluminum alloys. Slight variations in process parameters or work piece thickness could result in partial penetration welds during FSW of high-temperature alloys. This drawback has limited FSW from further developing and implementing it into production.

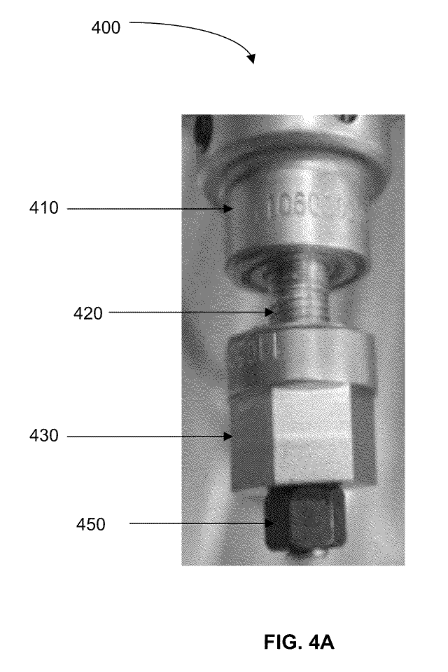

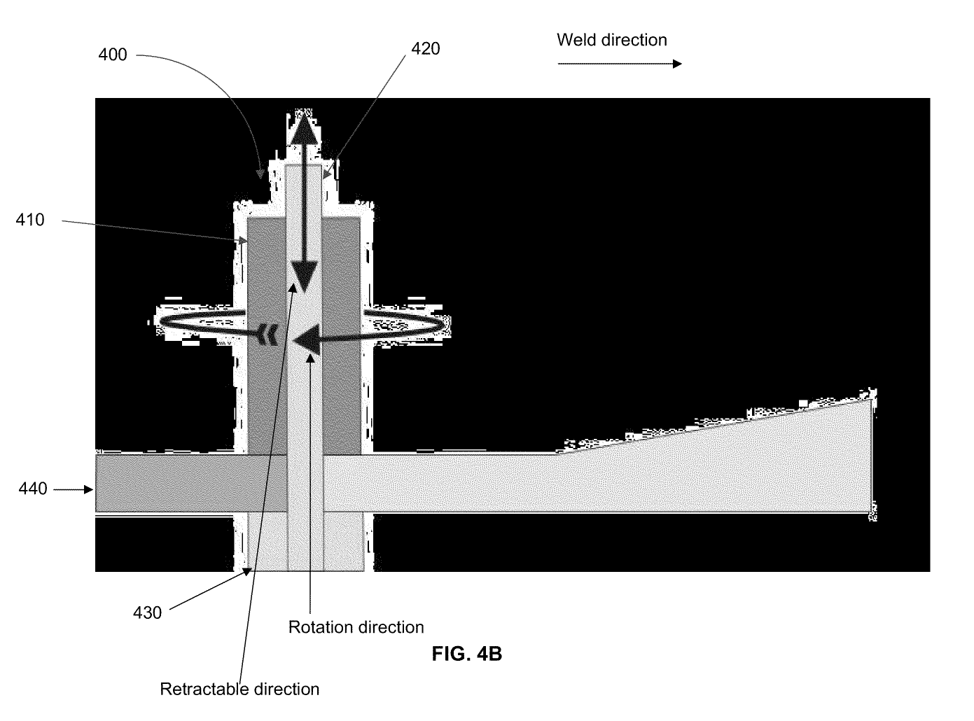

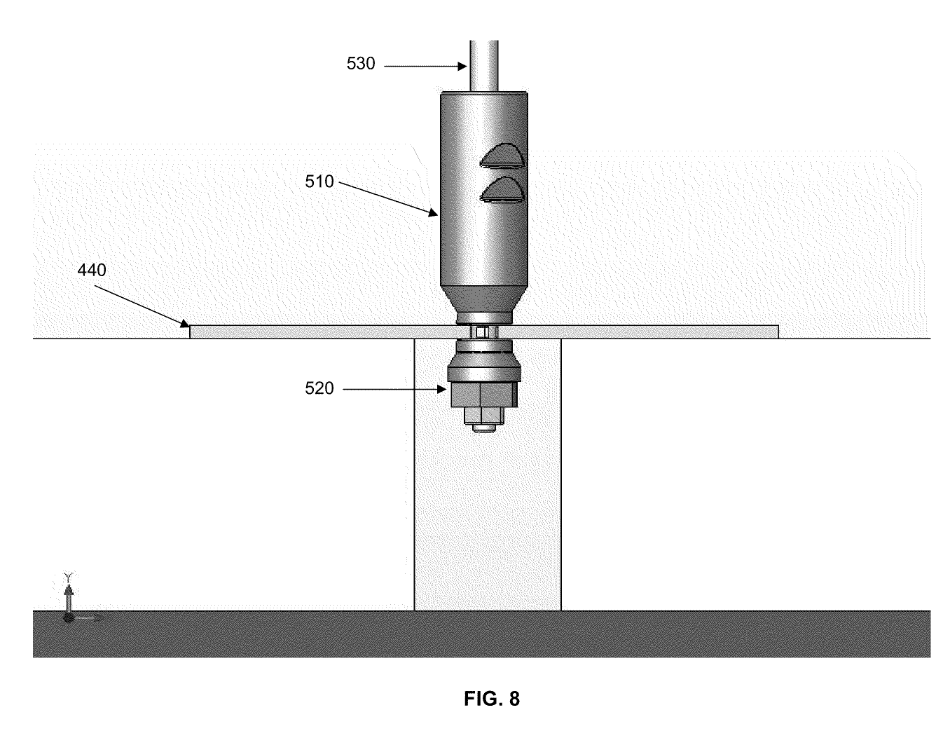

FIG. 4A illustrates one configuration of a pin tool device 400. The pin tool device 400 can be used for friction welding such as friction stir welding and/or self-reacting friction stir welding. The pin tool 400 comprises a top or upper shoulder 410, a pin 420, a bottom or lower shoulder 430 and a locking nut 450. The bottom shoulder 430 may be attached to the end of the RPT 100′ of FIG. 1B, for example. During welding, one or more workpieces 440 (see FIG. 4B and FIG. 8), are pinched or contacted by the top shoulder 410 and/or bottom shoulder 430 while they spin and traverse the one or more workpieces 440 to make a joint. Some examples of the one or more workpieces 440 or one or more metal plate(s) or metal alloy plate(s) comprise titanium alloys, inconel alloys, inconel 718, inconel 625, aluminum alloy families comprising 1000 series, 2000 series (e.g., A12024 and A2219), 5000 series, 6000 series, 7000 series and 8000 series, aluminum-lithium (Al—Li) alloys, Titanium (Ti) alloys such as Ti: 6-4 including alpha, beta, alpha-beta formation alloys, stainless steel alloys, copper and its alloys, lead, haynes 214, magnesium, zinc, mild steel, thermoplastics, dissimilar alloys and other steel alloys. Some configurations of a joint comprise butt joints, lap joints, T-joints and fillets. Unlike the fixed pin tool 100 and the retractable pin tool 100′, the friction stir welding tool 400 may not require a backing anvil. FIG. 1C and FIG. 1D illustrate one example of the pin tool device of FIG. 1A and FIG. 1B including the backing anvil 140. During welding, as the pin tool device 100, 100′ or 400 traverses the one or more workpieces 130, 130′ or 440 in the weld direction, pressure is applied to the one or more workpieces 130, 130′ or 440 from the pin tool device 100, 100′ or 400. The backing anvil 140 of FIG. 1C and FIG. 1D provides support to sustain pressure from the pin tool device 100 and 100′ during welding. Further, as illustrated in FIG. 4B, the pin 420 spins independently of the upper or top shoulder 410, and the pin 420 can move up and down independently from a shoulder 410 in order to change the pin length (see FIG. 1D).

In one aspect of the disclosure, the pin tool device 400 may overcome various drawbacks of the RPT 100′ and the fixed pin tool 100. For example, it may be difficult to obtain full penetration welds of high temperature alloys using the RPT 100′ and the fixed pin tool 100. This is so because the process window to achieve full penetration friction stir welds for high-temperature alloys is much smaller than with other alloys such as aluminum alloys. The friction stir welding technique may reduce this drawback due to the nature of the friction stir welding tool process. The friction stir welding tool process uses an additional shoulder, for example bottom or lower shoulder 430, attached to an end of a pin 420 through the workpiece thickness. This friction stir welding tool process may ensure that the there is no partial penetration issue on friction stir welding tool welds. Friction stir welding of high-temperature alloys may require use of refractory alloys as tool materials, for example, tungsten alloys, due to high temperature and force that the friction stir welding tools experience during friction stir welding process. These refractory alloys such as tungsten alloys are expensive and difficult to machine. Certain tungsten alloys such as commercially pure tungsten (CPW) are brittle at certain temperature range. Combination of the self-reacting process and use of refractory tool materials may require an innovative solution for pin tool designs to improve friction stir welding process (e.g. self-reacting friction stir welding process) for high-temperature alloys such as titanium and superalloys.

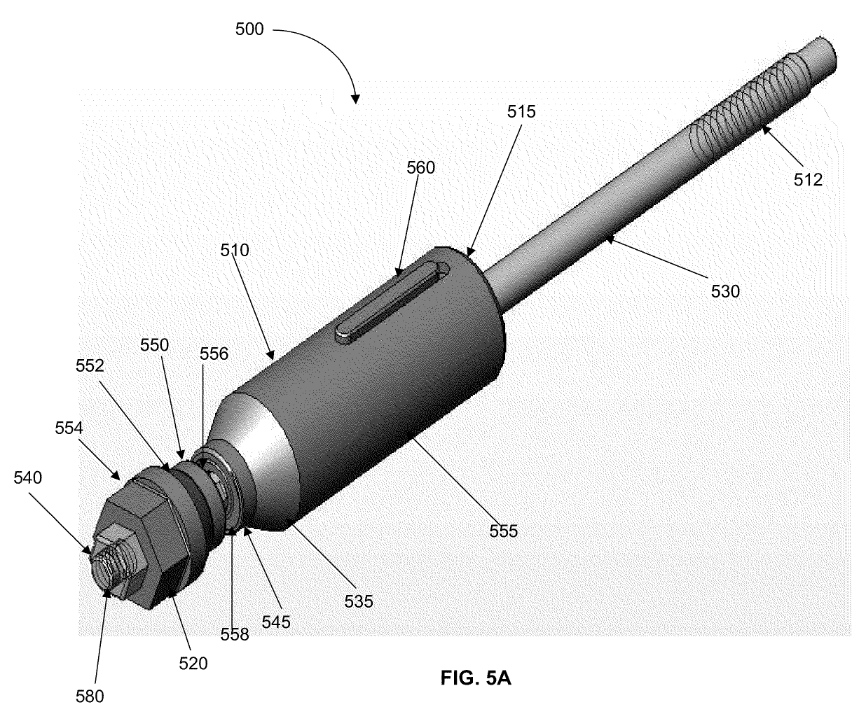

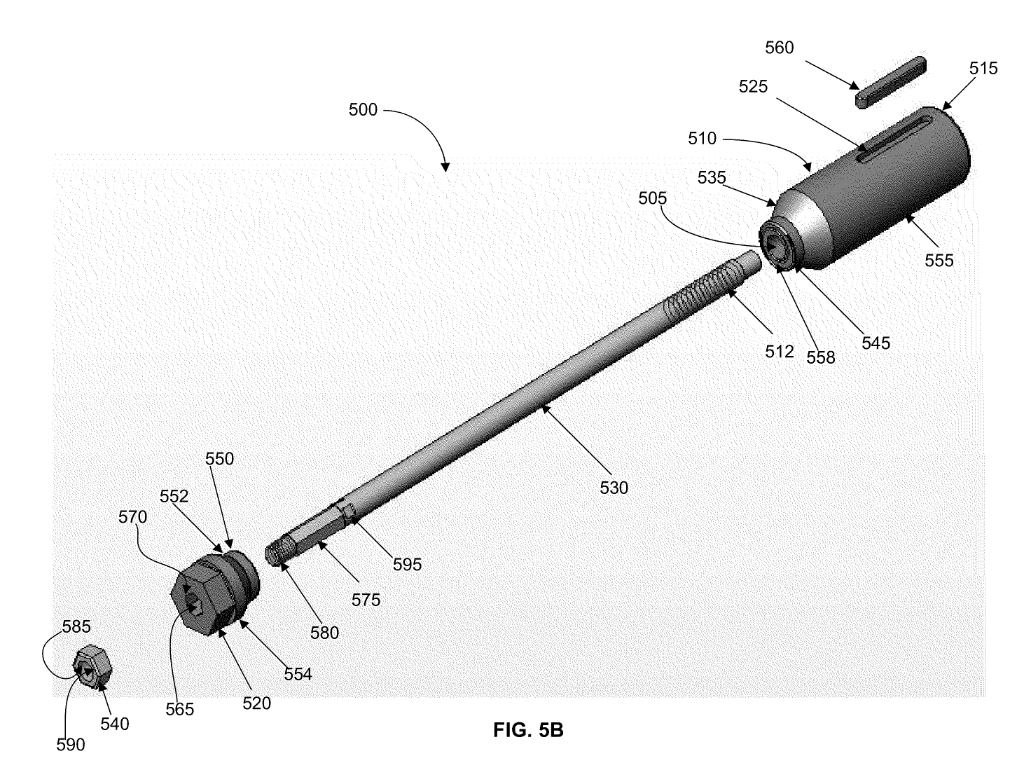

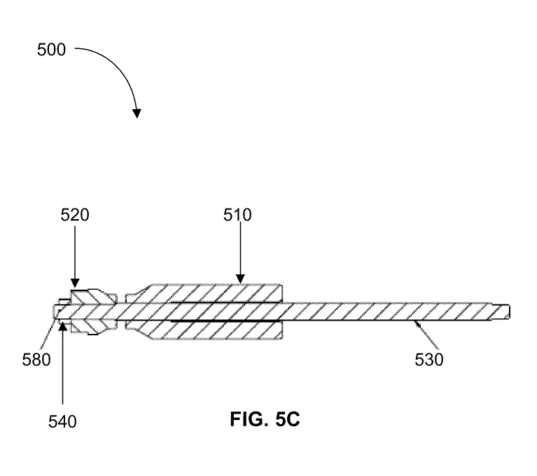

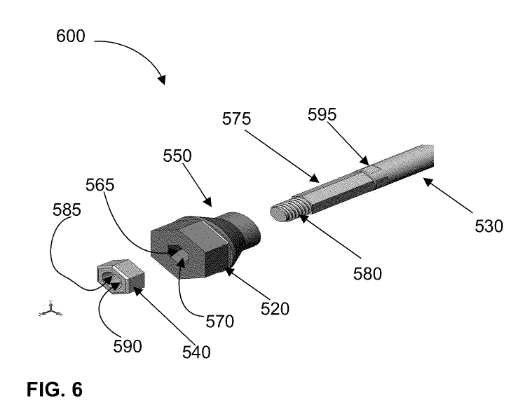

FIG. 5A illustrates an example of a pin tool or pin tool device 500, in accordance with various aspects of the subject disclosure. FIG. 5B is an exploded view of the pin tool device 500 shown in FIG. 5A. FIG. 5C is an example of a schematic cross-sectional view of one configuration of the pin tool device 500 shown in FIG. 5A. FIG. 6 is an example exploded view of a lower section 600 of the pin tool device 500. The pin tool device 500 may be used for friction stir welding a workpiece 440 of FIG. 4B, for example. Friction stir welding may comprise self-reacting friction stir welding. The self-reacting aspect of this type of welding is attributed to the upper and lower shoulders 510 and 520 of the pin tool device 500 creating a balance forge force at the workpiece 440, for example, and sufficient frictional heating to consume the entire thickness of the workpiece 440 along a joint.

The workpiece may be sometimes referred to as one or more workpieces, and a workpiece may comprise one or more parts (e.g., one or more plates for welding). The one or more plates may comprise metal(s), metal alloy(s) etc. Examples of the metals or metal alloys include titanium alloys, inconel alloys, steel, stainless steel, stainless steel alloys and other steel alloys and metals. The pin tool device 500 comprises an upper or top shoulder 510, a lower or bottom shoulder 520, a pin device 530, a locking device 540 and one or more flat devices 550. The pin tool device 500 is configured to rotate about an axis (e.g., an axis along the length of a pin device) during welding of one or more workpieces 440 or one or more plates. The frictional heating produced from the rotating pin tool device 500 plasticizes (e.g., softens) at least a portion of the material of the one or more workpieces in a weld joint. The rotating tool then traverses along a weld seam, generating a high strength, solid state weld.

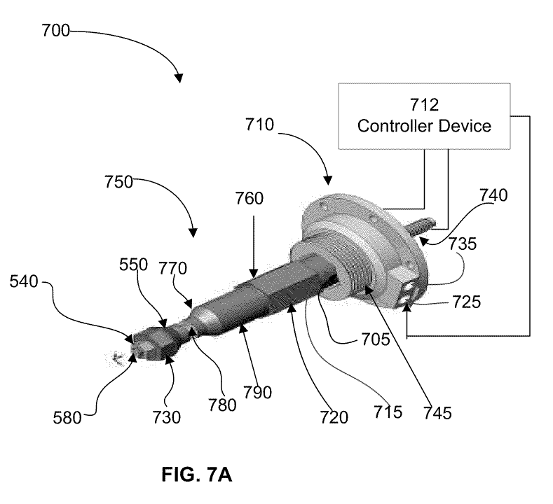

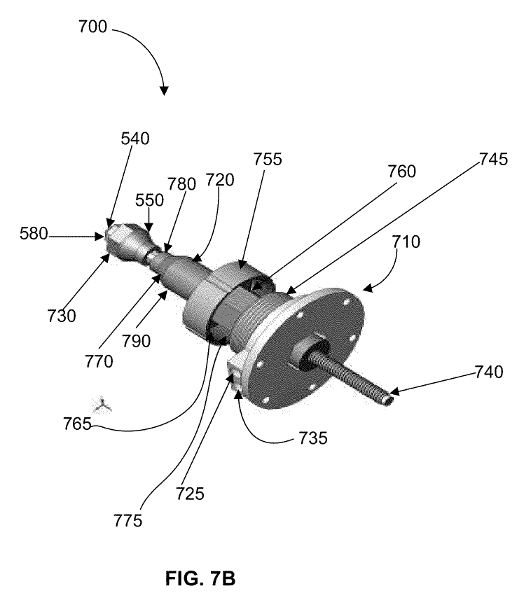

The upper shoulder 510 may comprise a first cavity 505, a second connection portion 515 and a key device 560 (e.g., a steel key). The steel key 560 may be a device that can be used to transfer torque from a head device or cooling spindle 710 (see FIG. 7A) to the top or upper shoulder 510 to create the necessary frictional heating. The steel key 560 may be used readily in the industry and may be replaced or used in conjunction with the hexagon shaped top shoulder 510. The upper shoulder 510 may also comprise a key device cavity 525 configured to receive the key device 560. A controller device 712, such as a driver (described with respect to FIG. 7A below), may be configured to rotate the upper shoulder 510 forming a rotatable upper shoulder. In some configurations, the upper shoulder 510 comprises a tapered end 535 that terminates at a bottom section 545 and a non-tapered end 555 above the tapered end 535. The bottom section 545 may comprise a surrounding area or diameter that is smaller than the surrounding area or diameter of the non-tapered end 555. The bottom section 545 may be a non-tapered bottom section and may have an upper shoulder flat end 558 to accommodate one or more flat devices such as machined flats. The upper shoulder 510 may also comprise a first cavity 505 therethrough.

The lower shoulder 520 may comprise a second cavity 565 and a third connection portion 570. At least a portion of an outer surface of the lower shoulder 520 may be hexagon shaped. The third connection portion 570 may be a multisided connection portion, for example, a hexagon shaped connection portion. The third connection portion 570 may be located within the second cavity 565. In some configurations, the lower shoulder 520 comprises a tapered end 552 that terminates at a lower section 550 and a non-tapered end 554 above the tapered end 552. The lower section 550 may comprise a surrounding area or diameter that is smaller than the surrounding area or diameter of the non-tapered end 554. The lower section 550 may be a non-tapered bottom section and may have a lower shoulder flat end 556 to accommodate one or more flat devices such as machined flats.

The one or more flat devices, for example one or more machined flats, may be disposed on the lower shoulder flat end 556 and/or on the upper shoulder flat end 558. In some configurations, when an upward forge force is applied to the underside of a workpiece 440, for example, the upward forge force may be balanced with a downward forge force applied at the bottom section 545 to create a forging cavity at the workpiece 440. The one or more flat devices may be arranged at 90 degree locations around the pin device 530. The one or more flat devices, in collaboration with the upper shoulder 510, the lower shoulder 520 and the pin device 530, are configured to stir material from the one or more workpieces 440 together during welding.

The pin device 530 may comprise a first end and a second end and at least a portion of the second end comprises a fourth connection portion 575. The fourth connection portion 575 may be a multisided connection portion, for example, a hexagon shaped connection portion. The fourth connection portion 575 may be located on an outer surface of the pin device 530. The fourth connection portion 575 of the pin device 530 may be configured to engage the third connection portion 570 of the lower shoulder 520. In one configuration, at least a portion of a bottom tip 580 of the second end of the pin device 530 is configured to engage the locking device 540. The locking device 540 may be configured to retractably engage the bottom tip 580 of the second end of the pin device 530. In other configurations, the bottom tip 580 of the second end of the pin device 530 and a connection portion 590 of the locking device 540 may be threaded. The connection portion 590 of the locking device 540 may be located within a locking device cavity 585. At least a portion of an outer surface of the locking device 540 and the lower shoulder 520 are multisided portions, for example, hexagon shaped connection portions. The locking device 540 can be a hex nut, for example. The locking device 540 can also be made of a high temperature alloy such as inconel. The high temperature alloy (such as inconel) hex nut can be screwed on to the threads at the pin device's bottom tip 580 to secure the lower shoulder 520 in place. In some configurations, the lower shoulder 520 is oversized to act as a minor heat sink for the frictional heat generated at a weld seam. In other configurations, the lower half of the lower shoulder's 520 exterior has a hexagon shaped and may be layered at least one portion with flat devices 550 to assist in removing the lower shoulder 520 after welding.

Prior to welding the one or more workpieces 440, the locking device 540 may be engaged to the bottom tip 580 of the second end of the pin device 530 after the third connection portion 570 is engaged to the fourth connection portion 575. The pin device 530 may be configured to retractably traverse the upper shoulder 510 via the first cavity 505. In some configurations, the pin device 530 may be configured to retractably traverse the lower shoulder 520 via the second cavity 565. The pin device 530 may be rotatably driven by a controller device 712 (of FIG. 7A). In other configurations, at least a portion of the first end of the pin device may be a threaded first end portion 512. In some configurations, the threaded first end portion 512 may be configured to engage the controller device 712.

During welding, one or more workpieces 440, for example one or more metal plate(s) or metal alloy plate(s) 440, are pinched or contacted by the upper shoulder 510 and/or the lower shoulder 520, as illustrated in FIG. 8, while the upper shoulder 510, the lower shoulder 520 and the pin device 530 spin and traverse the one or more workpieces 440 to make a joint. The pin device 530 and the rotatable upper shoulder 510 may be rotatably driven independently.

One configuration of the subject technology may include a retaining ring 595 on the second end of the pin device 530. The retaining ring 595 may be located on an outer surface of the pin device 530 above the fourth connection portion 575. The third connection portion 570 may be configured to slide over the bottom tip 580 of the second end of the pin device 530 up to a retaining ring 595 on the pin device 530 to engage the fourth connection portion 575. In other configurations, the lower shoulder 520 can slide over the threads at the bottom tip 580 of the pin tool 500 and fit up to the retaining ring 595 of the pin device 530 (see FIG. 5A). The one or more flat devices may be disposed between the lower section 556 and the retaining ring 595.

FIG. 7A and FIG. 7B illustrate examples of a friction stir welding tool or device 700, in accordance with various aspects of the subject disclosure. The friction stir welding tool 700 of FIG. 7A comprises a pin tool or pin tool device 750 and a head or head device 710. In some configurations, the pin tool device 750 may be the pin tool device 500 of FIG. 5A and FIG. 5B. In other configurations, the pin tool device 750 comprises, among others, an upper shoulder 720, a lower shoulder 730 (such as the lower shoulder 520 of FIG. 5A and FIG. 5B), a pin device 740 (such as the pin device 530), the head device 710 and one or more controller devices 712.

The upper shoulder 720 may comprise a first cavity (not shown) such as the first cavity 505 of FIG. 5A and FIG. 5B. At least a portion of the upper shoulder 720 may include an upper shoulder connection portion 760. The upper shoulder 720 may be rotatably driven by the one or more controller devices 712 resulting in a rotatable upper shoulder 720. In some configurations, the upper shoulder 720 comprises a tapered end 770 that terminates at a bottom section 780 and a non-tapered end 790 above the tapered end 770. The bottom section 780 (e.g., bottom section 545 of FIG. 5B) may comprise a surrounding area or diameter that is smaller than the surrounding area or diameter of the non-tapered end 790. The upper shoulder 720 may also comprise a first cavity (not shown), such as the first cavity 505, therethrough, where the pin device 740 is configured to retractably traverse the first cavity. The upper shoulder connection portion 760 may be a multisided connection portion, for example, a hexagon shaped connection portion.

The controller device 712 may be configured to rotatably drive the head device 710. The head device 710 may also comprise a first connection portion 705 and a rotatable head cavity 715. The first connection portion 705 may be a multisided connection portion such as a hexagon shaped connection portion. In some configurations, the first connection portion 705 may be located within the rotatable head cavity 715. The first connection portion 705 of the head device 710 may be configured to engage the upper shoulder connection portion 760. The head device 710 may further comprise an inlet 725 and an outlet 735 for water or a cooling fluid to circulate through the head device 710. In some configurations, the head device 710 can comprise a second head device connection portion 745 or second rotatable head connection portion. The second head device connection portion 745 may be located on an outer surface of the head device 710. The pin device 740 and the upper shoulder 720 may be configured to retractably traverse the head device 710 via the rotatable head cavity 715.

FIG. 7A further comprises one or more controller devices 712. In some configurations, the controller device may be configured to control the rotation of the pin tool device 750 and the head device 710. In other configurations, the controller device 712 may also be configured to control water or cooling fluid supply to the head device 710. The controller device 712 may be coupled to the pin tool device 750 and/or the head device 710. The one or more controller devices 712 may comprise a separate controller device 712 for the pin device 740, a separate controller device 712 for the head device 710 and a separate controller device 712 for the water or cooling fluid supply. The controller device 712 may include one or more drivers for controlling the rotation of the pin tool device 750 and the head device 710. In some configurations, the controller device may comprise a control unit coupled to one or more drivers, where the control unit controls the supply of energy, for example rotational energy, to the pin tool device 750 and/or the head device 710. In other configurations, the controller device 712 may comprise a control unit coupled to one or more water or cooling fluid supply, where the control unit controls the supply of water or cooling fluid, to the head device 710.

FIG. 7B illustrate another example of a friction stir welding tool or device, as described with respect to FIG. 7A, with a collar engagement portion 755. The collar engagement portion 755 may be engaged to the upper shoulder 720. In some configurations, the collar engagement portion 755 may be engaged to an outer surface of the upper shoulder 720. The collar engagement portion 755 may comprise a collar cavity 765 and a first head device connection portion 775 or first rotatable head connection portion. The first head device connection portion 775 may be located within the collar cavity 765. The first head device connection portion 775 can be configured to engage the second head device connection portion 745. In some configurations, the second head device connection portion 745 and the first head device connection portion 775 are threaded. The collar engagement portion 755 can be used to limit the upper shoulder 720 from dropping due to its own weight and the pin device (740)'s downward movement. In other configurations, the collar engagement portion 755 resembles a collet-clamping nut used with certain types of milling collets. The engagement of collar engagement portion 755 and the second head device connection portion 745 can be tightened and loosened with a standard collet nut wrench.

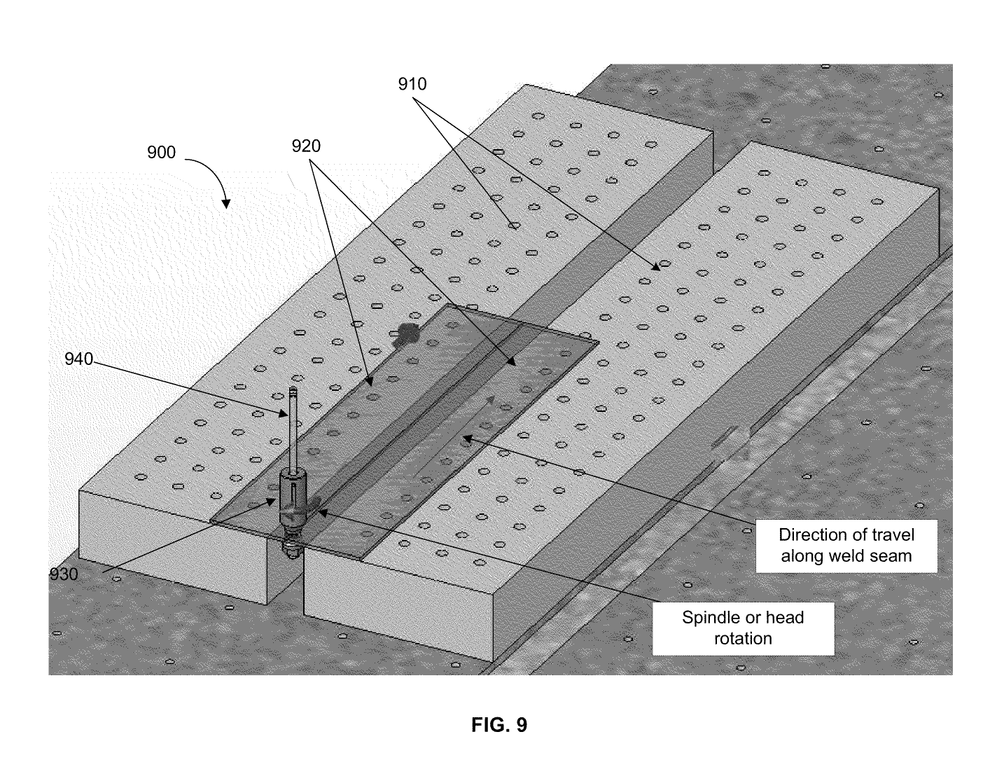

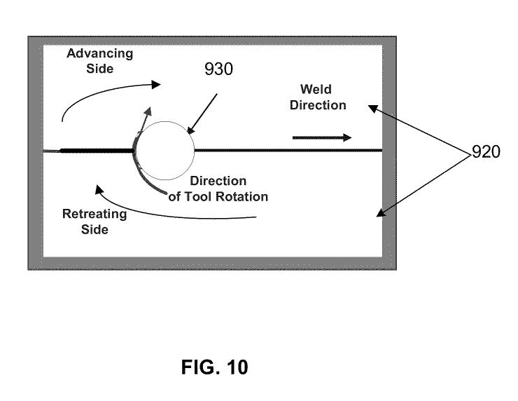

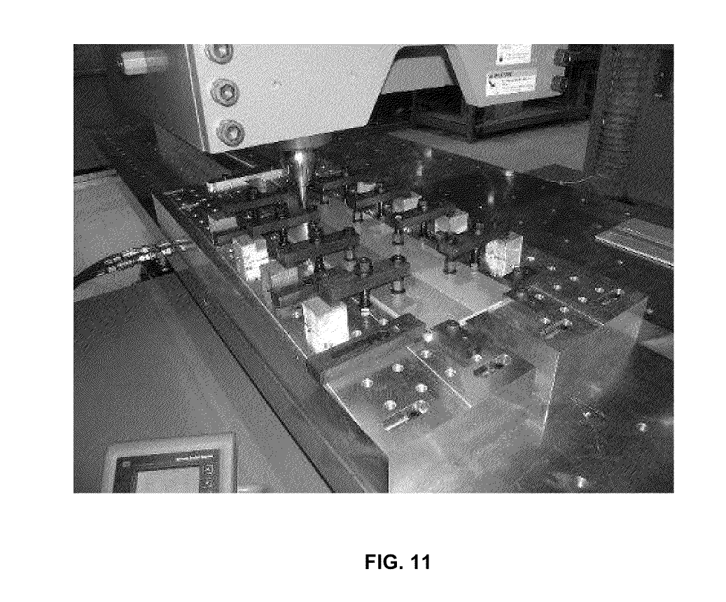

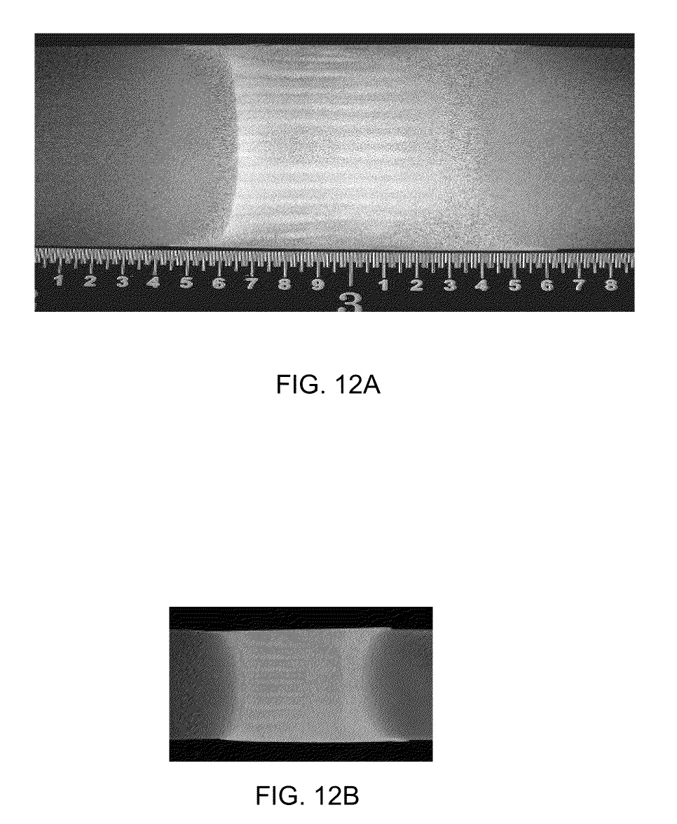

FIG. 9 illustrates welding equipment 900 according to one configuration of the subject technology. FIG. 10 illustrates an example of a top plan view of welding equipment. FIG. 11 illustrates one example of a welding equipment of FIG. 9. The welding equipment 900 comprises tooling fixtures 910, one or more workpieces 920, and the pin tool device 930 for welding the one or more workpieces 920. The pin tool device 930, such as the pin tool device 500 or 750, rotates about an axis during welding of one or more workpieces 920 or one or more plates. The frictional heating produced from the rotating pin tool device 930 plasticizes at least a portion of the material of the one or more workpieces 920 in a weld joint. The rotating pin tool device 930 then traverses along a weld seam, as illustrated in FIG. 9 and FIG. 10, generating a high strength, solid-state weld. Frictional heat may be generated, for example, between the bottom surface of an upper shoulder (e.g., 510 in FIG. 5A, FIG. 5B and FIG. 8) and the top surface of the workpieces 920 and/or between the top surface of the lower shoulder (e.g., 520 in FIG. 5A, FIG. 5B and FIG. 8) and the bottom surface of the workpieces 920 as the pin tool device 930 rotates.

During welding, the pin device 940 occupies a space between the workpieces 920. As the pin device 940 traverses along a weld seam in the weld direction, at least a portion of the workpieces 920 at or near the pin tool device 930 is plasticized at the advancing side, and the plasticized portion of the workpieces is hardened into a weld at the retreating side behind the pin tool device 930. The space occupied by the pin device 940 is filled with the material from the retreating side.

Returning to FIG. 7A and FIG. 7B, aspects of the subject technology use a unique design of hexagon shaped connection portions between the pin tool device 750 (via the upper shoulder 720, for example) and head device 710 or head or cooling spindle (head). One purpose of this design is to distribute the stress in an effort to prevent potential fracture of the upper shoulder 720 (made of refractory alloys that are brittle at certain temperature range such as brittle tungsten alloy, for example commercially pure tungsten (CPW), during welding process due to stress concentration. The inlet 725 and outlet 735 of the head device 710 are configured to circulate water or cooling fluid throughout the head device 710. The flowing water or fluid assists in regulating the temperature of the refractory alloy tool device such as friction stir welding tool 700, for example.

The lower shoulder 730 of the pin tool device 750 may also comprise the hexagon or other multisided shaped connection portion and hexagon shaped outer surface feature described above. Similar to the hexagon shaped connection portions featured in the upper shoulder 720, the lower shoulder's hexagon shaped connection portion and hexagon shaped outer surface can help to distribute stress and prevent the lower shoulder 730 from potential fracture during welding. The hexagon shaped connection portion 570, for example, can slide over the threads at the bottom tip 580 of the pin device 740, for example, and fit up to the retaining ring 595, for example, below the flat device 550 coupled to the pin device 740 or 530, for example. The flat devices 550, for example machined flats, can be arranged at 90 degree locations around the pin tool device 750 and may assist in stifling material together from the one or more workpieces 920 during welding.

Because this friction stir welding design of the present disclosure prevents potential tool stress fractures and maintains better control of heating temperature, the process for producing full penetration self-reacting FSW on high temperature alloys, for example, becomes more robust and repeatable. In some configurations, the hexagon shaped connection portions of the head device 710 and the upper shoulder 720, for example, allow the torque to be transferred by the six corresponding hexagon faces of the upper shoulder 720. Furthermore, the threaded collar feature, for example, supports the weight of the upper shoulder 720 and withstands the downward force exerted by pin device 740, when it moves out. The above described features of the subject technology allows for transmitting torque and resisting vertical load and to decrease the probability of deforming or breaking the upper or lower shoulders.

The lower shoulder 730 or 520, for example, also comprises hexagon connection portions and hexagon shaped outer surfaces that accept torque from the six corresponding hexagon faces on the pin tool device 750, for example. This hexagon connection portions and hexagon shaped outer surfaces can mitigate the threat of stress concentrations causing fracture of the lower shoulder 730 or 520. The hexagon connection portions may allow for easier removal of the lower shoulder 730 or 520 after welding.

Friction stir welding can provide various benefits over fusion welding. According to certain aspects of the disclosure, the friction stir welding process may achieve various process advantages or enhancements. One advantage of friction stir welding is reduced weld process time (e.g., single pass to weld up to 1″ thick plates rather than requiring multiple passes to weld plates that are 0.250″ in thickness or greater). Another advantage is fewer process variables or reduced variability (e.g., three main variables as opposed to ten variables required for fusion welding). Yet another advantage may be simplified joint geometry (e.g., butt joints rather than grooves at thicker gages). Other advantages may include ease of automation and control, less dependency on operators, reduction in consumables (e.g., no gases, tungsten electrodes, filler metals), reduced health hazards (e.g., elimination of arc burn and ultraviolet radiation), reduced surface weld preparation (e.g., usage of Scotch brite and iso propyl alcohol (IPA) wipe rather than draw filing), ease of weld bead geometry inspection, ease of welding dissimilar alloys, and a wide range of part configurations (e.g., linear, complex curvature, circular and spherical).

According to certain aspects of the disclosure, the friction stir welding process, as described below may achieve various material enhancements. Material enhancements may include, for example, enhancements in mechanical properties, reduced weld defects, microstructural benefits, reduced shrinkage, and reduced distortion. In one aspect, the mechanical properties are enhanced due to, for example, improved strength (e.g., up to 50% increase), improved fracture toughness, improved ductility, and reduced knock-down factors. In one aspect, weld defects are reduced due to, for example, elimination of porosity and elimination of solidification cracking. In one aspect, microstructural benefits include parent material chemistry with limited or no dilution from filler metals and fine grains as compared to normal cast structure from arc weld.

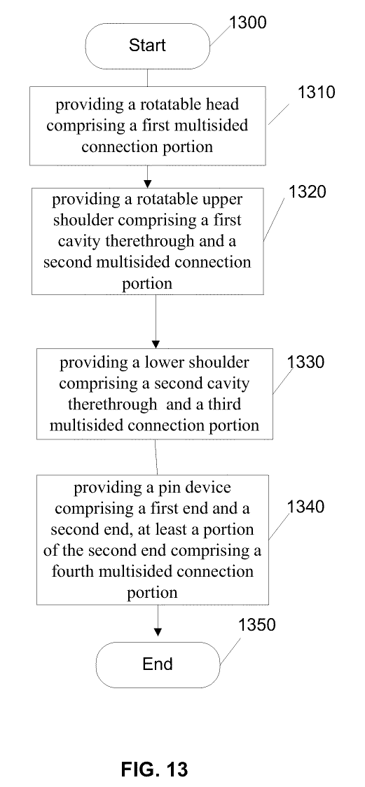

FIG. 13 illustrates an example of a friction stir welding process according to one aspect of the subject technology. The process begins in block 1300. The process continues to block 1310 where a rotatable head comprising a first multisided connection portion is provided. The process continues to block 1320 where a rotatable upper shoulder comprising a first cavity therethrough and a third multisided connection portion is provided. The second multisided connection portion may be configured to engage the first multisided connection portion of the rotatable head. The process continues to block 1330 where a lower shoulder comprising a second cavity therethrough and a third multisided connection portion is provided. In block 1340, a pin device comprising a first end and a second end is provided. At least a portion of the second end comprises a fourth multisided connection portion. The fourth multisided connection portion of the pin device can be configured to engage the third multisided connection portion. The pin device can be configured to retractably traverse the rotatable upper shoulder via the first cavity wherein the rotatable upper shoulder, the pin device and the lower shoulder can be configured to friction stir weld a workpiece. The process ends in block 1350.

The foregoing description is provided to enable a person skilled in the art to practice the various configurations described herein. While the present subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

Terms such as “top,” “bottom,” “outer,” “upper,” “lower,” and the like as used in this disclosure should be understood as referring to an arbitrary frame of reference, rather than to the ordinary gravitational frame of reference. Thus, a top surface, a bottom surface, an outer surface, an upper surface and a lower surface may extend upwardly, downwardly, diagonally, or horizontally in a gravitational frame of reference.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A friction stir welding apparatus comprising:
a head comprising a first multisided connection portion;
a rotatable upper shoulder comprising a first cavity therethrough and a second multisided connection portion, the second multisided connection portion configured to engage the first multisided connection portion of the head;
a lower shoulder comprising a second cavity therethrough and a third multisided connection portion; and
a pin device comprising a first end and a second end, at least a portion of the second end comprising a fourth multisided connection portion, the fourth multisided connection portion of the pin device configured to engage the third multisided connection portion, the pin device configured to retractably traverse the rotatable upper shoulder via the first cavity, wherein the rotatable upper shoulder, the pin device and the lower shoulder are configured to friction stir weld a workpiece.

2. The apparatus of claim 1, wherein the first, second, third and fourth multisided connection portions are hexagon shaped connection portions.

3. The apparatus of claim 1, wherein at least a portion of an outer surface of the lower shoulder is hexagon shaped.

4. The apparatus of claim 1, wherein the third multisided connection portion is located within the second cavity.

5. The apparatus of claim 1, wherein the third multisided connection portion is configured to slide over a bottom tip of the second end of the pin device to engage the fourth multisided connection portion.

6. The apparatus of claim 5, further comprising a locking device configured to engage the bottom tip of the second end of the pin device.

7. The apparatus of claim 6, further comprising threads on the bottom tip of the second end of the pin device to engage threads on the locking device.

8. The apparatus of claim 1, wherein at least one or both of the upper and lower shoulders are configured to make contact with the workpiece while the pin device, the rotatable upper shoulder and the lower shoulder spin and traverse the workpiece to make a joint during welding.

9. The apparatus of claim 1, wherein one or more controller devices are configured to engage the pin device and the head.

10. The apparatus of claim 1, wherein the pin device and the rotatable upper shoulder are configured to be rotatably driven independently.

11. The apparatus of claim 1, wherein the head is coupled to the rotatable upper shoulder, the head is rotatable, and the head and the rotatable upper shoulder are configured to rotate together, and
wherein the lower shoulder is coupled to the pin device, the lower shoulder and the pin device are rotatable, and the lower shoulder and the pin device are configured to rotate together.

12. The apparatus of claim 1, wherein the head further comprises an inlet and an outlet for liquid to circulate through the head.

13. The apparatus of claim 1, further comprising a collar engagement portion coupled to the rotatable upper shoulder, the collar engagement portion comprising a collar cavity and a first rotatable head connection portion.

14. The apparatus of claim 13, wherein the first rotatable head connection portion is located within the collar cavity.

15. The apparatus of claim 1, wherein the head comprises a rotatable head cavity therethrough and a second rotatable head connection portion.

16. The apparatus of claim 15, wherein the first multisided connection portion is located within the rotatable head cavity, and the second multisided connection portion is located on an outer surface of the rotatable upper shoulder.

17. The apparatus of claim 15, wherein the second rotatable head connection portion is located on an outer surface of the head.

18. The apparatus of claim 15, further comprising a collar engagement portion coupled to the rotatable upper shoulder, the collar engagement portion comprising a collar cavity and a first rotatable head connection portion,
wherein the first rotatable head connection portion is configured to engage the second rotatable head connection portion.

19. The apparatus of claim 1, wherein the fourth multisided connection portion is on an outer surface of the pin device.

20. The apparatus of claim 5, wherein the third multisided connection portion is configured to slide over the bottom tip of the second end of the pin device up to a retaining ring on the pin device to engage the fourth multisided connection portion.
